(19) United States
(12) Patent Application Publication
(10) Pub. No.: US 2024/0140517 A1
(43) Pub. Date: May 2, 2024

(54) MOTOR VEHICLE STEERING WHEEL WITH RETRACTABLE RIM AND TORQUE LIMITER

(71) Applicant: AUTOLIV DEVELOPMENT AB, Vargarda (SE)

(72) Inventors: Matthis BARRITAULT, Vautebis (FR); Sebastien CASSIN, Migné (FR); Thomas LEBOEUF, Ouzilly (FR)

(21) Appl. No.: 18/279,753

(22) PCT Filed: Mar. 1, 2022
(86) PCT No.: PCT/EP2022/055169

§ 371 Date: Sep. 1, 2023

(30) Foreign Application Priority Data
Mar. 4, 2021 (FR) FR210108

(51) Int. Cl. B62D 1/06

(52) U.S. Cl. CPC B62D 1/06

(57) ABSTRACT

The invention relates to a vehicle steering wheel comprising:—a central part such as a steering wheel hub; —a movable structure comprising at least a portion of a rim mounted so as to pivot with respect to the central part between:—a driving position in which the vehicle can be steered by a driver; —and at least one retracted position; —an actuator for pivoting the movable structure between the driving position and the retracted position; —a movement transmission mechanism for transmitting movement between the actuator and the movable structure, characterised in that the transmission mechanism comprises a torque limiter.

### TECHNICAL FIELD OF THE INVENTION

The present invention generally relates to motor vehicle steering wheels.

More particularly, the invention relates to a steering wheel with an orientable or retractable rim.

### STATE OF THE ART

In the prior art of vehicle steering wheels, a motorized folding steering wheel system is known, for example from document US-B1-10.562.558, comprising: a steering wheel having a rim forming a substantially continuous ring which is pivotably connected to a central structure which is configured to be mounted on a steering column, and including an electric motor which is configured to pivot the rim from a vertical position—corresponding to a state allowing the vehicle to be driven—to a substantially horizontal stowed or retracted position, allowing other usages or uses of the steering wheel and its rim. Additionally, the steering wheel system comprises one or more additional system(s) for locking the rim in its vertical driving position, each of which is presented in the form of a dedicated locking system. Such a design is in particular bulky, heavy and expensive. Furthermore, the steering wheel of the prior art does not make it possible to warn the user or driver that it is preferable not to lock the steering wheel during the pivoting of the steering wheel from the driving position or in the retracted position. Furthermore, the steering wheel of the prior art does not make it possible to protect the components of the steering wheel or the driver in the event of the steering wheel being locked by the driver.

One aim of the present invention is to address the disadvantages of the prior art mentioned above and in particular, first of all, to propose a motor vehicle steering wheel, at least part of the rim of which is pivotable, can be protected from being locked by the user or driver, while also protecting that person and warning them of the danger of such locking, while proposing a compact and economical assembly for pivoting and locking. Furthermore, the small volume available in the steering wheel to integrate a rotation device requires significant compactness of all the components. A compact drive motor will have the disadvantage of producing a low rotational torque. This reduced torque could be easily locked by the user, which could damage the engine. Thus, the steering wheel according to the present invention makes it possible to warn the user or the driver that it is preferable not to lock the steering wheel during the pivoting of the steering wheel from the driving position or in the retracted position, while being equipped with a sufficiently powerful actuator for this purpose.

### DISCLOSURE OF THE INVENTION

To this end, a first aspect of the invention relates to a vehicle steering wheel comprising:
a central part such as a steering wheel hub;
a movable structure comprising at least a portion of a rim mounted so as to pivot with respect to the central part between:
a driving position wherein the vehicle can be steered by a driver;
and at least one retracted position;
an actuator for pivoting the movable structure between the driving position and the retracted position;
a movement transmission mechanism for transmitting movement between the actuator and the movable structure, characterized in that the steering wheel or transmission mechanism comprises a torque limiter arranged to limit a torque transmitted to the movable structure.

This makes it possible to propose a steering wheel with a compact and economical arrangement, while making it possible to protect the steering wheel from excessive torque which could take place when the user or the driver holds the steering wheel firmly when the steering wheel pivots, so as to protect both the components of the steering wheel and the driver as well. In addition, this allows an actuator to be integrated into the steering wheel that is sufficiently powerful to perform the function, limiting the risks of injury and damage.

In other words, the torque limiter is arranged to limit a rotational torque or force transmitted between the actuator and the movable structure (both toward the movable structure).

Advantageously, the torque limiter is arranged to disengage, at least temporarily, the actuator from the movable structure, beyond a predetermined torque between the actuator and the movable structure.

In other words, beyond a predetermined torque, the torque limiter can completely or partially prevent the transmission of the torque between the actuator and the movable structure.

A clutch refers to a mechanism that makes it possible respectively to establish or interrupt a communication between an actuator and a part to be moved (respectively engage and disengage) without stopping the actuator.

In general, a clutch is not a torque limiter. Indeed, a clutch makes it possible for example to couple the actuator with a moving part, without a torque-limiting consideration. In some cases, as for a vehicle clutch, a clutch is even designed not to slide or disengage if the actuator reaches or delivers its maximum torque. In this case, the clutch may be provided to resist the maximum torque of the actuator without slipping or disengaging, with a safety margin of 10%, 20% or even more.

A torque limiter is installed in a drivetrain so as to normally not slide, that is to say to transmit a torque or a movement, as long as the input torque does not exceed a maximum value. Beyond this maximum torque, the torque limiter allows the transmission chain to slide or even disengage. The torque limiter acts as a mechanical fuse, reversibly (the torque limiter can again automatically transmit torque and/or movement if the torque to be transmitted falls below the maximum torque), or irreversibly (the torque limiter, once triggered, can no longer transmit torque and/or movement as long as the torque limiter is not reset or replaced).

This makes it possible to propose a steering wheel to warn the user of abnormal use of the steering wheel, and to prompt that person to release the steering wheel so as not to damage it or be injured.

Advantageously, the predetermined torque between the actuator and the movable structure can be equal to or higher than 0.9 Nm, preferentially equal to or higher than 1 Nm, very preferentially equal to or higher than 1.2 Nm.

This ensures the safety of the steering wheel components and the safety of the user or driver.

Advantageously, the torque limiter may comprise at least one first recess, and at least one protrusion arranged to:
be lodged in the first recess when the torque limiter is engaged, and
be dislodged from the first recess when the torque limiter is disengaged.

Advantageously, the torque limiter may further comprise a second recess, adjacent to the first recess, and the protrusion is arranged to:
be lodged again into the second recess after having been dislodged from the first recess.

In other words, when the protrusion is lodged in again, the torque limiter is again engaged.

This makes it possible to propose a steering wheel with the torque limiter, that is easy and compact to manufacture, making it possible to avoid injury or material damage, while warning the user (by noise and/or a small impact, such as a snap, a tapping, or a click) of unwanted operation if it retains the steering wheel during pivoting. It may also be a retention of the steering wheel by the driver for a predetermined time (for example 100 ms), during which time the torque limiter does not disengage. In addition, this makes it possible to continue to ensure the pivoting function in case of overtorque, passing through the adjacent recess, so as to allow use of the steering wheel. Of course, if the torque to be transmitted remains greater than the predetermined torque after the protrusion is passed into the adjacent recess, the torque limiter disengages again, and passes to the next recess along, and so on.

Advantageously, the first recess may be a groove extending radially, and the protrusion may be a rib that projects and extends radially, arranged to fit into the groove.

The term “groove” is understood to mean a long and narrow notch, with a cross-section which can be rectangular, made in the thickness of a part (for example one made of metal or steel) and intended to be used for assembling or to receive sliding parts.

Also, the protrusion may be key-shaped.

Advantageously, the first recess may be a notch, and the torque limiter may further comprise a first leaf spring, extending radially so as to form the protrusion, and arranged to engage with the notch.

The term “notch” is understood to mean a cut made in a solid body (here a metal) or in an object, and which removes a part.

Advantageously:
the first recess may be an opening,
the protrusion may be a pin arranged at a distal end of an axis of rotation of the torque limiter, and
the torque limiter may comprise a portion made of a flexible material and arranged between the pin and the axis of rotation of the torque limiter.

This makes it possible to propose a steering wheel with the torque limiter, according to construction variants.

Advantageously, the transmission mechanism may further comprise second leaf springs arranged to press the protrusion into the first recess. The second leaf springs can be arranged to press the drive plate against the toothed input member.

This makes it possible to adjust the predetermined torque and to ensure that the elements are properly pressed together, in particular so as to compensate for the operating gaps.

Advantageously, the steering wheel or transmission mechanism may further comprise a device for blocking or locking the torque limiter in or near a predetermined position of the movable structure, for example the driving position. This makes it possible to ensure that the torque limiter cannot be in an intermediate position while the movable structure is locked in the driving position, which could cause unwanted residual gaps in the drive chain. A complete blocking or locking may be provided, that is to say one which consists of making a relative sliding between the actuator and the movable structure impossible, or blocking or locking may be provided which consists of imposing an additional tension on the torque limiter to allow sliding in the driving position only at an even higher torque than when outside the driving position. In the case of complete blocking or locking, an index can be provided which secures the movable structure in the central part, in the case of blocking or locking which consists of imposing an additional tension, a slope or a cam which imposes an additional tension on the elastic member, which imposes friction in the torque limiter, can be envisaged.

Advantageously, the device for locking the torque limiter may be an additional plate arranged to limit an axial movement of the torque limiter.

Advantageously, the actuator can be a motor.

This makes it possible to propose a compact and reliable actuator.

Advantageously, the actuator can comprise two discs each comprising a planar friction surface, and arranged facing one another at the planar friction surfaces thereof, and at least one pressure spring arranged to urge the two discs against one another.

This prevents the torque limiter from remaining in an intermediate position that could induce operating gaps.

Advantageously, the transmission mechanism may comprise:
a drive plate rigidly connected to the actuator,
a toothed input member arranged to be driven by the actuator via the torque limiter,
the toothed input member being arranged to directly or indirectly rotate the movable structure into the retracted position thereof.

The torque limiter can be arranged between the actuator and the movable structure. The torque limiter can be arranged between the drive plate and the toothed input member.

Advantageously:
the first recess is arranged in either the toothed input member or the drive plate, and
the protrusion is arranged on the other one of the toothed input member and the drive plate.

This makes it possible to propose a steering wheel with a compact arrangement.

Another aspect of the invention relates to a vehicle comprising a steering wheel according to the first aspect.

This makes it possible to propose a vehicle with a steering wheel and a torque limiter with a compact and economical arrangement, making it possible to avoid damage and injuring the user or driver, in particular when that person retains the steering wheel when it pivots, while alerting the driver to this danger and inviting that person to remove their hand from the steering wheel.

### DESCRIPTION OF THE FIGURES

Other characteristics and advantages of the present invention will become more apparent upon reading the detailed description of several embodiments of the invention, which are provided by way of example but in no way limiting, and illustrated by the attached drawings, in which:

FIG. 1 is a perspective view of a first embodiment of a vehicle steering wheel which is shown in the driving position of the rim;

FIG. 2 is a top view of the steering wheel shown in FIG. 1;

FIG. 3 is a perspective detail view which shows certain components of a movement-transmission mechanism which equips the steering wheel shown in FIGS. 1 and 2;

FIG. 4 is an exploded perspective view of a torque limiter to be mounted in the steering wheel according to the first embodiment;

FIG. 5 is an exploded perspective detail view of the torque limiter on the side opposite FIG. 4, according to the first embodiment;

FIG. 6 is an assembled and detailed perspective view of the torque limiter, according to the first embodiment;

FIG. 7 is an assembled view, in cross-section and in elevation, of the torque limiter, according to the first embodiment;

FIG. 8 is a cross-sectional and elevation view of the torque limiter in its near environment, according to the first embodiment;

FIG. 9 is a cross-sectional and elevation view of the torque limiter, according to a second embodiment of the steering wheel;

FIG. 10 is a perspective view of the torque limiter, according to the second embodiment of the steering wheel, on the side opposite to FIG. 9;

FIG. 11 is a perspective view of the torque limiter, according to a third embodiment of the steering wheel;

FIG. 12 is a perspective view of the torque limiter, according to the third embodiment, on the side opposite to FIG. 11;

### DETAILED DESCRIPTION OF THE EMBODIMENTS

### First Embodiment

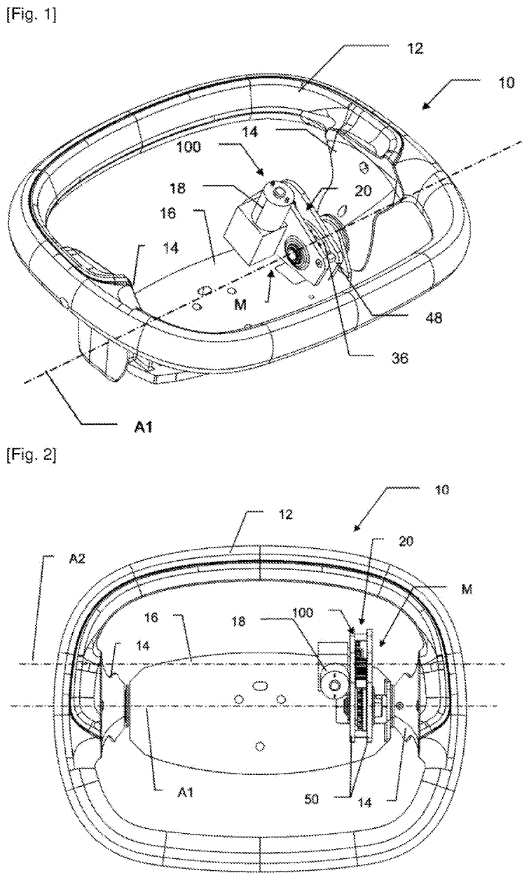

FIGS. 1 and 2 show a steering wheel 10 comprising a rim 12 connected by arms 14 to a central portion 16, also referred to as a hub, which is arranged to allow the coupling of the steering wheel to a steering column of the vehicle or to an electric steering gear box (not shown).

In order to improve the ergonomics of use of the vehicle, the rim 12 is at least partially mounted articulated relative to the central part 16, so as to be able to pivot in one or two directions about a primary axis A1 orthogonal to the axis of rotation of the steering wheel, in order to be positioned angularly:
either in a driving position wherein the plane of the rim 12 is typically orthogonal to an axial direction of the central part 16 which coincides with the axis of rotation of the steering wheel and of the steering column during the driving of the vehicle;
or in a retracted position, also called the console position, wherein the plane of the rim 12 is then inclined relative to the direction of the central part 16, in particular for a user to be able for example to place a computer on the rim 12.

The possibility of changing the angular position is not necessarily limited to pivoting the entire rim 12, but can also relate to only a portion of the rim 12—for example only one half of the rim, such a rim portion constituting a movable structure of the rim in the sense of the invention.

By way of non-limiting example, in order to pivot the rim 12, the steering wheel 10 includes herein a side module M for driving and locking the rim 12. The side module M is arranged herein adjacent to the rear arm 14 of the steering wheel 10.

The module M essentially combines a motorized actuator 18, a transmission mechanism 20 (or drive mechanism 20) between the actuator 18 and the rim 12 and the steering wheel (or the transmission mechanism directly) comprising a torque limiter 100 to limit a torque that can be transmitted to the rim 12.

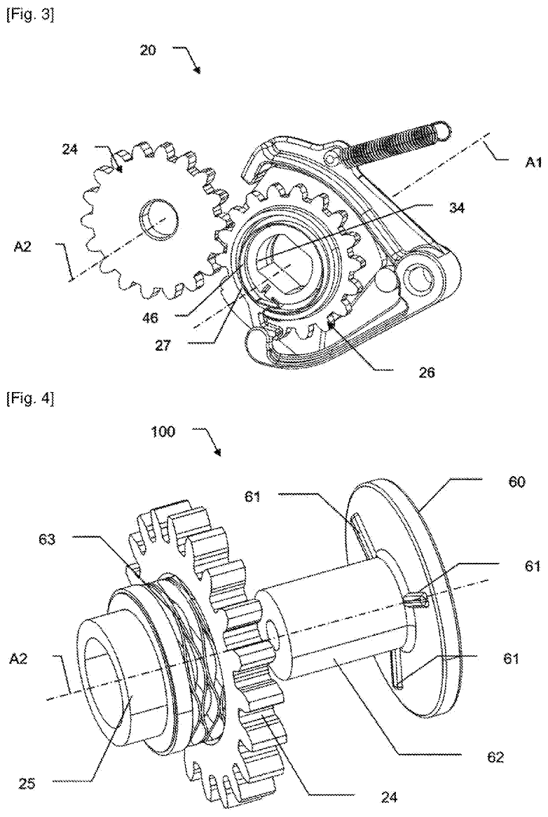

FIG. 3 shows the transmission mechanism 20 with:
a movement input gear 24 belonging to the transmission mechanism 20 which is rotated about a secondary axis A2 (also called axis of rotation A2) by the actuator 18;
a drive sprocket 26 for pivoting the rim 12 which permanently meshes with the input gear 24 (as a non-limiting example, the drive sprocket 26 is mounted rotating about the primary pivoting axis A1 of the rim 12).

For the rotational connection in both directions between the drive sprocket 24 and the rim 12, FIG. 3 also shows a hub 34 that is capable of being rotatably secured to the rim 12 and which extends axially through the drive sprocket 26.

Furthermore, a spring 46, here made in the form of a spiral spring, is interposed between a rim 27 of the drive sprocket 26 which extends axially forward and the hub 34, and permanently ensures a resilient return of the drive sprocket 26.

As can be seen in FIGS. 1 and 2, the module M herein has two parallel reinforcement plates 50 between which the input gears 24 and drive sprockets 26 are arranged, as well as the hub 34, these various components also being mounted so as to rotate relative to these two reinforcement plates 50. In addition, the motorized actuator 18 is attached to the front reinforcement plate 50.

The input gear 24 constitutes a toothed input member for the movement to be transmitted at least to the drive sprocket 26.

Alternatively, it is possible to replace the input gear 24 with a toothed inner crown gear or even with an optionally straight toothed rack.

The actuator 18 is for example a rotary electric motor 18 (or motor 18) which is optionally associated with a gearbox or with a gear reducer to form an electric gear motor. In this case, a rotating output shaft drives—directly or indirectly—the toothed input member such as the input gear 24.

Alternatively, the output shaft can drive a screw of a worm-and-nut system in order to drive the toothed input member in both directions via a member in the shape of a rack.

The torque limiter is preferably installed co-axially with the input gear 24, also called the toothed input member.

FIG. 4 is an exploded perspective view of the torque limiter 100 to be mounted in the steering wheel 1 according to the first embodiment.

Preferably, the drive mechanism 20 comprises a drive plate 60 driven by the actuator 18. Preferably, the drive plate 60 is rigidly connected to the shaft of the motor 18.

The torque limiter 100 here comprises three ribs 61, on a flat face of the drive plate 60 perpendicular to the axis of rotation A2. The ribs 61 are an example of protrusion. The drive plate 60 further comprises a shaft 62 arranged to engage with a hub 25 of the input gear 24.

The torque limiter 100 further comprises second leaf springs 63 arranged to press the gear 24 against the drive plate 60. The second leaf springs 63 may be wave washers, wave springs, conical washers, or even a coil spring.

Preferably, the ribs 61 are evenly distributed on the face of the drive plate 60, that is, here every 120 degrees. More or fewer ribs 61 can be provided on the drive plate 60.

FIG. 5 is an exploded perspective detail view of the torque limiter 100 on the side opposite FIG. 4, according to the first embodiment of the steering wheel 10.

The gear 24 comprises twelve grooves 64. Preferably, the grooves 64 are evenly distributed over a face of the gear 24, opposite the drive plate 60. The grooves 64 are arranged to receive the ribs 61, that is to say they have a corresponding shape. The grooves 64 are examples of recesses (or first recesses or second recesses).

When the drive plate 60 is assembled with the gear 24, the ribs 61 are lodged in the grooves 64. Thus, a torque can be transmitted between the drive plate 60 and the gear 24. When the torque to be transmitted is greater than a predetermined torque, the ribs 61 will be dislodged from the grooves 64. If the motor 18 continues to rotate, the ribs 61 will become lodged again in the grooves 64 adjacent to the grooves 64 wherein they were lodged before being dislodged. A knocking sensation is thus transmitted to the user or driver, inviting that person to release the steering wheel 1 so that the pivoting of the steering wheel 1 can be carried out without damaging the components of the steering wheel 1 or injuring the user. Thus, a haptic device is produced. Furthermore, the disengagement of the torque limiter causes an axial movement of the gear 24 along the axis A2.

The second leaf springs 63 are thus arranged to press the ribs 61 into the grooves 64.

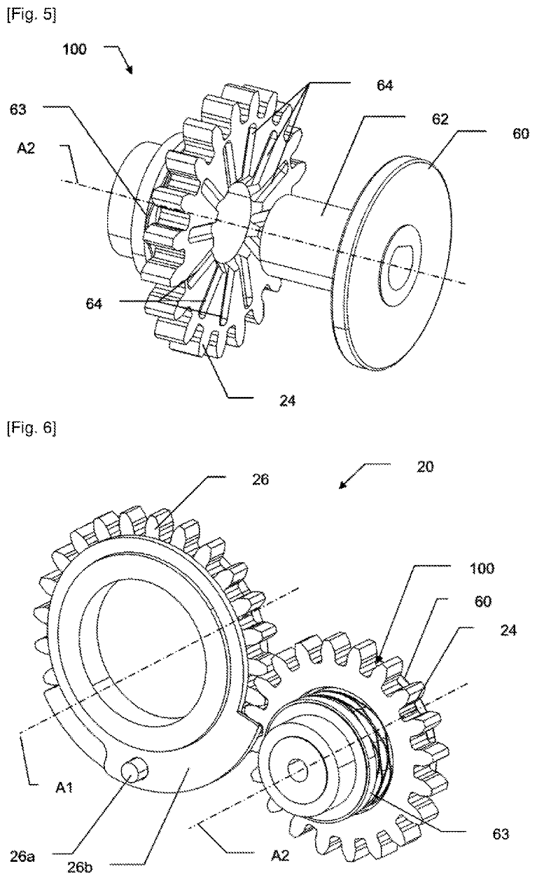

FIG. 6 is an assembled detailed perspective view of the torque limiter 100 according to the first embodiment of the steering wheel 10.

The drive sprocket 26 is shown with an additional plate 26b attached to the drive sprocket 26. The additional plate 26b makes it possible to block the torque limiter 100 when the movable structure 12 is in or near a predetermined position, for example in the driving position. This makes it possible to ensure that the torque limiter 100 cannot be in an intermediate position, typically the ribs 61 not engaged in the grooves 64, while the movable structure is locked in the driving position.

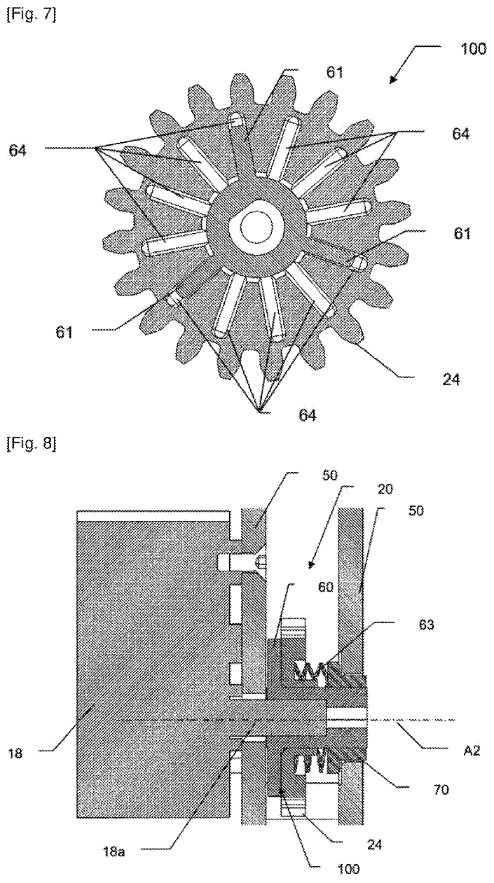

FIG. 7 is an assembled view, in cross-section and in elevation, of the torque limiter 100 according to the first embodiment of the steering wheel 10.

The ribs 61 are lodged in the grooves 64 (that is, the drive plate 60 is engaged with the gear 24), when the torque to be transmitted is below the predetermined torque. When the torque to be transmitted is greater than the predetermined torque, the ribs 61 are dislodged from the grooves 64 (which corresponds to a disengagement of the drive plate 60 from the gear 24). When the drive plate 60 continues to rotate, the ribs 61 can be lodged again in the adjacent grooves 64.

Preferably, a rib 61 of the three ribs 61 is used to center the drive plate 60 on the gear 24, and the other two ribs 61 serve to balance the system during the disengagement (or unlocking).

In other words, the recess is a groove 64 extending radially, and the protrusion is a rib 61 that projects and extends radially, arranged to fit into the groove 64.

By adapting the geometry of the ribs 61 and the grooves 64 and/or the second leaf springs 63, the predetermined torque can be adjusted.

Furthermore, it is possible to provide a rounded face at the ribs 61 or between the grooves 64, so as to prevent the torque limiter 100 from being blocked in an intermediate position, that is to say so as to ensure that the ribs 61 engage easily with the adjacent grooves 64 in the event the torque to be transmitted is greater than the predetermined torque. In addition, this makes it possible to limit the torque necessary for the ribs 61 to become lodged again in the adjacent groove 64.

FIG. 8 is a cross-sectional and elevation view of the torque limiter 100 in its near environment, according to the first embodiment of the steering wheel 10.

The motor 18 comprises a shaft 18a which is coaxial with the input gear 24, and the second leaf springs 63 are arranged between the gear 24 and a bearing 70 of the transmission mechanism 20, so as to ensure a pressing of the gear 24 on the drive plate 60. As seen above, the second leaf springs 63 press the ribs 61 in the grooves 64 (not shown in FIG. 8).

### Second Embodiment

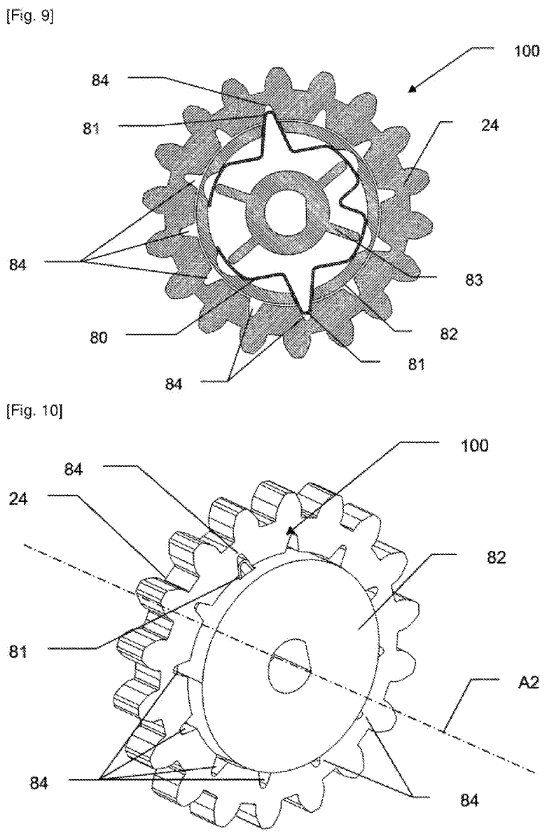

FIG. 9 is a view, in cross-section and in elevation, of the torque limiter 100 according to a second embodiment of the steering wheel 10.

The reference numbers of the other embodiments are repeated whenever possible for the elements they have in common.

The torque limiter 100 comprises a first leaf spring 80 in the form of a drive spring hoop, having two protrusions 81 projecting toward one of the notches 84 of the gear 24. The spring blade 80 is pressed, inside the gear 24, against a flange 82 having internal ribs 83. The protrusions 81 can engage in the notches 84 through two corresponding openings in the flange 82. The notches 84 are examples of recesses (or first recesses or second recesses).

As previously, the protrusions 81 are lodged in the notches 84 when the torque to be transmitted is less than the predetermined torque. The protrusions 81 can be dislodged from the notches 84 when the torque to be transmitted is greater than the predetermined torque and can further engage with the adjacent notches 84 when the motor 18 continues to rotate.

In other words, the recess is a notch 84, and the first leaf spring 80 extends radially outside the flange 82 so as to form the protrusion 81, and arranged to engage with the notch 84.

By choosing the stiffness of the first leaf spring 80, the size of the protrusion 81 and the shape of the notch 84, it is possible to adjust the predetermined torque.

The disengagement of the torque limiter 100 causes a radial movement of the protrusion 81 relative to the gear 24.

FIG. 10 is a perspective view of the torque limiter 100 according to the second embodiment of the steering wheel 10.

The torque limiter 100 is seen from the side opposite that of FIG. 9.

### Third Embodiment

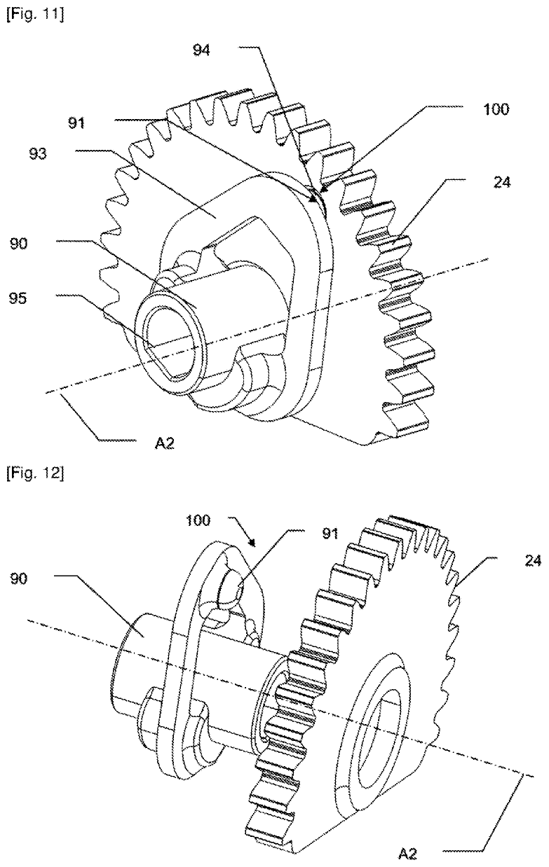

FIG. 11 is a perspective view of the torque limiter 100 according to the third embodiment of the steering wheel 10.

The torque limiter 100 comprises a transmission shaft 90 in order to transmit the rotational torque of the motor 18, via the flat 95. The torque limiter 100 further comprises a pin 91 arranged at a distal end of a flexible portion 93. The flexible portion 93 is rigidly connected to the transmission shaft 90 and forms a leaf spring. The gear 24 further comprises an opening 94 arranged to receive the pin 91. The opening 94 is an example of a recess (or first recess or second recess). The pin 91 is an example of protrusion.

In other terms, the recess is an opening 94, and the protrusion is a pin 91 arranged at a distal end of the axis of rotation of the torque limiter 100, and the torque limiter 100 comprises a flexible portion 93 made of a flexible material and arranged between the pin 91 and the axis of rotation A2 of the torque limiter 100 and gear 24.

The disengagement of the torque limiter 100 causes an axial movement of the pin 91.

FIG. 12 is an exploded perspective view of the torque limiter 100 on the side opposite FIG. 11.

The pin 91 is thus arranged at a predetermined radial distance from the axis of rotation A2 of the transmission shaft 90, which makes it possible to adjust the predetermined torque, in cooperation with the choice of the flexible material, such as a thin strip made of spring steel, or a plastic or polymeric material, or even composite material (a blade or a rod made of metal, for example steel, overmolded with a plastic material such as a plastic, a polymer, optionally with a filler material such as fibers, for example silicone, rubber, polyamide, polypropylene, and optional glass fibers etc.).

It will be understood that various modifications and/or improvements which are obvious to a person skilled in the art may be made to the different embodiments of the invention described in the present description without departing from the scope of the invention.

In addition, it is possible to combine the embodiments.

1-15. (canceled)

16. A vehicle steering wheel comprising:
a central part such as a steering wheel hub;
a movable structure comprising at least a portion of a rim mounted so as to pivot with respect to the central part between:
a driving position wherein the vehicle can be steered by a driver;
and at least one retracted position;
an actuator for pivoting the movable structure between the driving position and the retracted position;
a movement transmission mechanism for transmitting movement between the actuator and the movable structure, wherein the steering wheel comprises a torque limiter arranged to limit the torque transmitted to the movable structure.

17. The vehicle steering wheel according to claim 16, wherein the torque limiter is arranged to disengage, at least temporarily, the actuator from the mobile structure, beyond a predetermined torque between the actuator and the mobile structure.

18. The vehicle steering wheel according to claim 17, wherein the predetermined torque between the actuator and the mobile structure is equal to or higher than 0.9 Nm, preferably equal to or higher than 1 Nm, very preferably equal to or higher than 1.2 Nm.

19. The vehicle steering wheel according to claim 16, wherein the torque limiter may comprise at least one first recess, and at least one protrusion arranged to:
be lodged in the first recess when the torque limiter is engaged, and
be dislodged from the first recess when the torque limiter is disengaged.

20. The vehicle steering wheel according to claim 19, wherein the torque limiter further comprises a second recess, adjacent to the first recess, and the protrusion is arranged to:
be lodged again into the second recess after having been dislodged from the first recess.

21. The vehicle steering wheel according to claim 19, wherein:
the first recess is a groove extending radially, and
the protrusion is a rib that projects and extends radially, arranged to fit into the groove.

22. The vehicle steering wheel according to claim 19, wherein:
the first recess is a notch, and
the torque limiter also comprises a first leaf spring, extending radially so as to form the protrusion, and arranged to engage with the notch.

23. The vehicle steering wheel according to claim 19, wherein:
the first recess is an opening,
the protrusion is a pin arranged at a distal end of an axis of rotation of the torque limiter, and
the torque limiter comprises a portion made of a flexible material and arranged between the pin and the axis of rotation of the torque limiter.

24. The vehicle steering wheel according to claim 19, wherein the transmission mechanism further comprises second leaf springs arranged to urge the protrusion into the first recess.

25. The vehicle steering wheel according to claim 19, wherein the transmission mechanism further comprises an additional plate arranged to limit an axial movement of the torque limiter.

26. The vehicle steering wheel according to claim 16, wherein the torque limiter comprises two discs each comprising a planar friction surface, and arranged facing one another at the planar friction surfaces thereof, and at least one pressure spring arranged to urge the two discs against one another.

27. The vehicle steering wheel according to claim 16, wherein the transmission mechanism comprises:
a drive plate rigidly connected to the actuator,
a toothed input member arranged to be driven by the actuator via the torque limiter,
the toothed input member being arranged to directly or indirectly rotate the movable structure into the retracted position thereof.

28. The vehicle steering wheel according to claim 27, wherein:
the first recess is arranged in either the toothed input member or the drive plate, and
the protrusion is arranged on the other one of the toothed input member and the drive plate.

29. The vehicle steering wheel according to claim 16, comprising a device for blocking or locking the torque limiter in or near a predetermined position of the mobile structure, for example the driving position.

30. The vehicle steering wheel according to claim 16 in combination with a vehicle.
